(19) United States
(12) Patent Application Publication
(10) Pub. No.: US 2013/0291966 A1
(43) Pub. Date: Nov. 7, 2013

(54) QUICK-RELEASE VACUUM PUMP

(71) Applicant: Ho-Young Cho, Seoul (KR)

(72) Inventor: Ho-Young Cho, Seoul (KR)

(73) Assignee: Korea Pneumatic System Co., Ltd.

(21) Appl. No.: 13/978,068

(22) PCT Filed: Dec. 7, 2011
(86) PCT No.: PCT/KR2011/009410

§ 371 Date: Jul. 2, 2013

(30) Foreign Application Priority Data
Jan. 3, 2011 (KR) 10-2011-0000081

(51) Int. Cl. F17D 1/00

(52) U.S. Cl. CPC F17D 1/00
USPC 137/544

(57) ABSTRACT

A quick-release vacuum pump. A vacuum pump part has a cylindrical hollow area extending between an inlet and an outlet and nozzles disposed in series inside the hollow area and have slots therein, both ends of the nozzles communicating with each other between the inlet and the outlet. A release part includes a support tube formed above a suction port, a skirt-type check valve to be moved up and down by air pressure to open and close the support tube, and a pressure chamber formed in a passage communicating with the suction port and passes by a valve skirt. A filter material disposed between the suction port and the support tube allows discharge air to pass through upward when the pump part operates, and is cleaned by air supplied to the suction port through the support tube from the pressure chamber when the pump part stops operating.

### TECHNICAL FIELD

The present invention relates, in general, to a quick-release vacuum pump and, more particularly, to a quick-release vacuum pump which can simply and quickly release the state of vacuum, and in which the operation of filtering using a filter and the operation of cleaning the filter are naturally and repeatedly carried out.

### BACKGROUND ART

In the present invention, a vacuum pump that operates using compressed air that is supplied at a high speed and evacuates the space inside a suction pad. When the vacuum pump operates, vacuum or a negative pressure is formed in the space inside the suction pad. A vacuum transport system holds an object using the negative pressure obtained in this fashion, and transports the object to an intended place.

In general, the vacuum pump includes a casing which has an inlet and an outlet and nozzles which are arrayed in series inside the casing. A space, for example, inside the suction pad extends through the casing and communicates with the inside of the nozzles. Therefore, when compressed air is supplied through the inlet and passes through and is ejected from the nozzles at a high speed, the inner space is evacuated, thereby creating the vacuum or negative pressure for transporting the object.

Once the object has been transported, the vacuum pad must be quickly separated from the object in order to repeatedly carry out subsequent works. However, since the separation is not quickly carried out, that is, it cannot be carried out simply by only stopping the supply of compressed air, a specific design and method capable of enforcing the suction pad to be separated from the object are required.

According to related methods that are known, in addition to vacuum lines which are connected to the nozzles, release lines are separately designed such that each line can be supplied with compressed air and be electrically controlled. When the supply of compressed air to the vacuum lines is stopped, the release lines are opened to supply compressed air to the suction pad, so that the vacuum of the inner space of the suction pad is released or broken, thereby separating the suction pad from the object.

These methods are, in fact, available and being used, since they can quickly separate the suction pad from the object by supplying the compressed to the suction pad. However, these methods have problems in that their electronic/mechanical designs and structures for realizing the methods are complicated, malfunctions are frequent, and maintenance is difficult. Due to these and other problems, these methods are considerably disadvantageous in terms of economic competitiveness, productivity, workability or the like.

### DISCLOSURE

### Technical Problem

Accordingly, the present invention has been made keeping in mind the above problems occurring with the vacuum pump of the related art, and is intended to provide a vacuum pump, neither the design nor the structure of which is complicated, and which can uniformly and accurately operate without malfunctions.

It is also intended to provide a vacuum pump which can more quickly release the state of vacuum. It is also intended to provide a vacuum pump in which an air filter is disposed at a suitable position such that the filter can be naturally and repeatedly cleaned without being manipulated.

### Technical Solution

In an aspect, the present invention provides a quick-release vacuum pump constructed inside a casing which includes a compressed air inlet and a compressed air outlet formed in opposing side sections and a suction port formed in a bottom. The quick-release vacuum pump includes: a vacuum pump part which includes a cylindrical hollow area which extends through the casing between the inlet and the outlet, one portion of the hollow area communicating with the suction port, nozzles which are disposed in series inside the hollow area and have slots therein, both ends of the nozzles communicating with each other between the inlet and the outlet; a release part which includes a support tube which is formed above the suction port, a skirt-type check valve which is moved up and down by air pressure to open and close the upper portion of the support tube, and a pressure chamber which is formed at a terminal of a passage which communicates with the suction port and passes by a valve skirt; and a filter material which is disposed between the suction port and the support tube, wherein the filter material allows discharge air that is introduced to pass through upward when the pump part operates and is cleaned by air that is supplied to the suction port below through the support tube from the pressure chamber when the pump part stops operating.

It is preferred that the nozzles be disposed inside a cylindrical body which has a through-hole in a wall, thereby forming one pump cartridge, with which the nozzles are mounted inside the hollow area. In addition, it is preferred that mounting ribs be formed on the upper end of the suction port such that the filter material is firmly mounted.

### Advantageous Effects

According to the present invention as described above, when the compressed air starts being supplied to the pump part, the pressure chamber is filled with a certain portion of the compressed air. At the moment that the supply of the compressed air is stopped, the air inside the pressure chamber flows backward, thereby releasing the state of vacuum. Therefore, the vacuum pump according to the present invention can be more simply designed and realized than vacuum pumps of the related art, and can uniformly and accurately operate continuously without malfunctions. In addition, there are no operations required for opening/closing lines and supplying the releasing compressed air. In addition, there are no prior operations, such as an electronic circuit operation, required for such operations. Accordingly, it is possible to more quickly release the state of vacuum.

In the meantime, the air inside the pressure chamber is ejected through the filter material when the state of vacuum is released. At this time, impurities that have been stuck to the bottom of the filter material are detached and removed by the air pressure. Consequently, it is possible to naturally and repeatedly clean the filter material without separately cleaning the filter material.

### DESCRIPTION OF DRAWINGS

FIG. 1 is a perspective view showing the contour of a vacuum pump according to the present invention;

FIG. 2 is an enlarged cross-sectional view along line “A-A” in FIG. 1;

FIG. 3 is an enlarged cross-sectional view along line “B-B” in FIG. 1;

FIG. 4 is a view explaining the vacuum operation of the vacuum pump according to the present invention; and

FIG. 5 is a view explaining the release operation of the vacuum pump according to the present invention;

<Major Reference Numerals and Symbols of the Drawings>

| | |
|---|---|
| 10: vacuum pump | 20: casing |
| 21: inlet | 22: outlet |
| 23: suction port | 30: vacuum pump part |
| 31: hollow area | 32a, 32b, 32c: nozzle |
| 33: slot | 34: body |
| 35: through-hole | 36: cartridge |
| 40: release part | 41: support tube |
| 42: check valve | 43: skirt |
| 44: passage | 45: pressure chamber |
| 51: rib | |

### BEST MODE

The above and other features and effects of the present invention will be more apparent from the following description of certain exemplary embodiments taken in conjunction with the accompanying drawings. In the following drawings, a vacuum pump according to the present invention is designated with reference numeral 10.

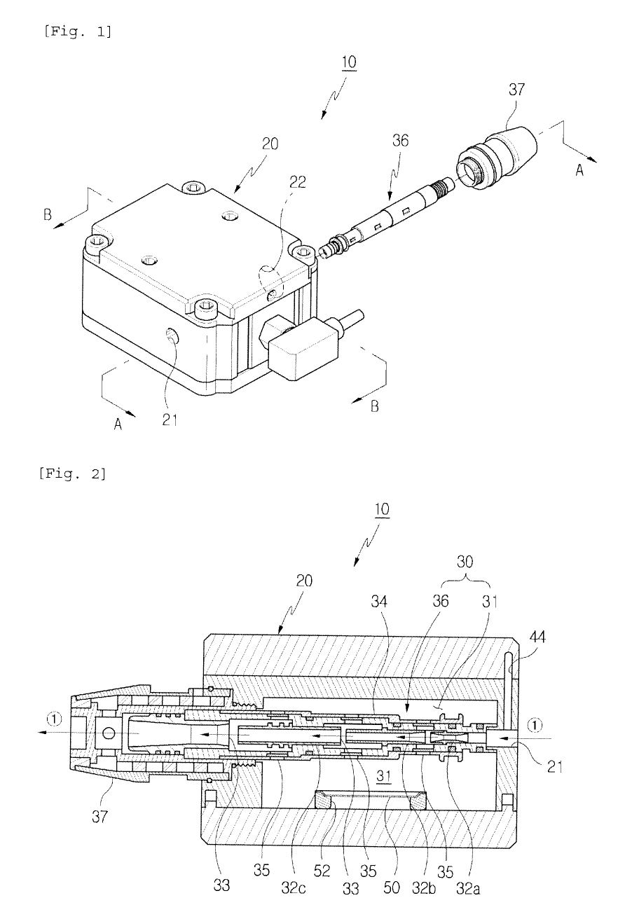

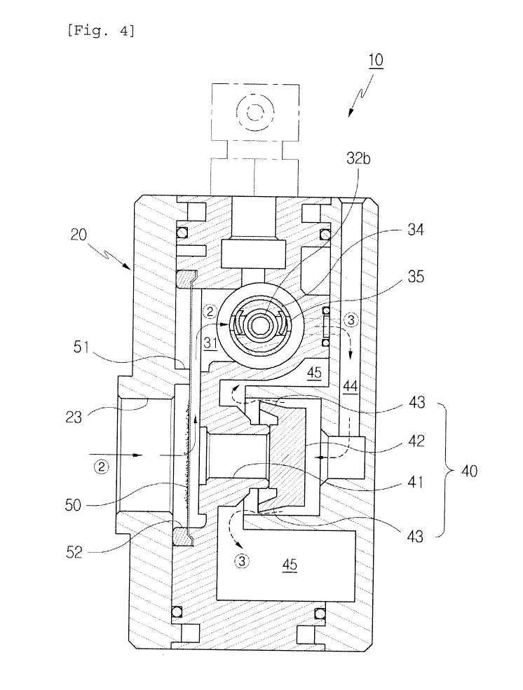

Referring to FIG. 1 to FIG. 3, the vacuum pump 10 according to the present invention includes a casing 20 having a predetermined shape together with other components which are constructed and formed inside the casing 20. The casing 20 includes a compression air inlet 21 and a compression air outlet 22 which are disposed at opposing side sections and a suction port 23 which is disposed in the bottom. In addition, as inner components of the casing 20, a vacuum pump part 30, a release part 40 and a filter material 50 are included.

The vacuum pump part 30 is a component that evacuates the inner space of a suction pad and the like connected to the suction port 23 of the casing 20, thereby creating vacuum or a negative pressure.

The vacuum pump part 30 has a cylindrical hollow area 31 which extends through the casing between the inlet 21 and the outlet 22, one portion of the hollow area 31 communicating with the suction port 23. The vacuum pump part 30 also includes nozzles 32a, 32b and 32c which are disposed in series inside the hollow area 31. Both ends of the nozzles communicate with each other between the inlet 21 and the outlet 22. Slots 33 are formed in the nozzles 32a, 32b and 32c. The nozzles 32a, 32b and 32c include two or more nozzles, and are so-called “multi-stage nozzles” in which the inner diameters thereof gradually increase. In the figures, reference numeral 37 indicates a silencer which is disposed adjacent to the outlet 22 of the casing 20.

Although it is possible to directly dispose the nozzles 32a, 32b and 32c inside the hollow area 31, the nozzles 32a, 32b and 32c are disposed inside the hollow area 31 via a cylindrical body 34 according to this embodiment. Specifically, the nozzles 32a, 32b and 32c are arrayed in series inside the body 34, which forms one pump cartridge 36 including through-holes 35 formed in the wall thereof.

Since the pump cartridge 36 is disposed in the hollow area 31, the nozzles 32a, 32b and 32c are also properly arranged and fixed inside the hollow area 31. In addition, the hollow area 31 can communicate with the inside of the cartridge 36 and the nozzles 32a, 32b and 32c via the through-holes 35. This structure can be considered advantageous over the structure in which the nozzles 32a, 32b and 32c are directly disposed in the hollow area 31 in terms of mountability, assemblability and firmness.

The release part 40 is a component which quickly releases or breaks the vacuum or the negative pressure that was created in response actuation of the vacuum pump part 30.

The release part 40 includes a support tube 41 which protrudes above the suction port 23 of the casing 20, a skirt-type check valve 42 which is disposed above the support tube 41 and is moved up and down by air pressure in order to open and close the upper opening of the support tube 41, and a pressure chamber 45 which is formed at the terminal of a passage 44 which passes by a valve skirt 43 portion in the suction port 23.

In this structure, the compressed air that is supplied through the inlet 21 and flows through the passage 44 can flow through the valve 42 into the pressure chamber 45 while pressing against the valve skirt 43 portion. However, the air filled in the pressure chamber 45 does not return in the reverse direction but flows toward the suction port 23 through the support tube 41, the upper opening of which is opened by the air-lift of the valve 42.

In addition, the filter material 50 is a filtering material that filters the air that has entered through the suction port 23 and then allows the air to flow into the hollow area 31.

The filter material 50 that is applied here can have any shape, such as a pad type or a pleated type. The filter material 50 is disposed over the suction port 23, and serves to filter the air that has passed through the suction port 23. Specifically, the filter material 50 is disposed between the suction port 23 and the support tube 41, and has mounting ribs 51 on the upper end of the suction port 23 such that the filter material 50 can be firmly mounted. The ribs 51 are required to be designed such that they do not obstruct the flow of the air. In the figures, reference numeral 52 is a gasket.

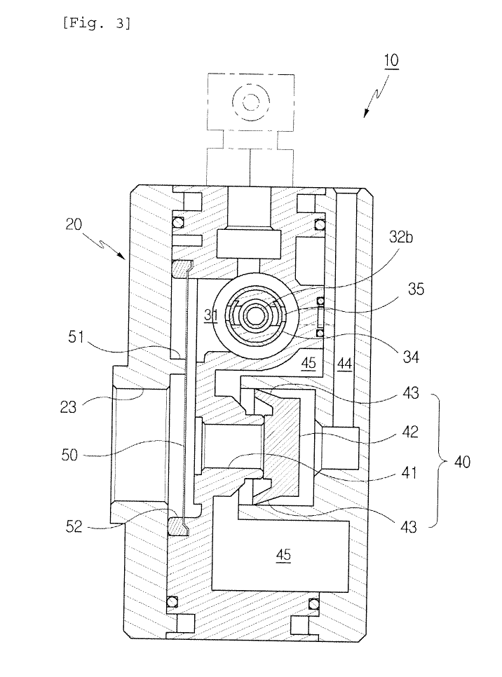

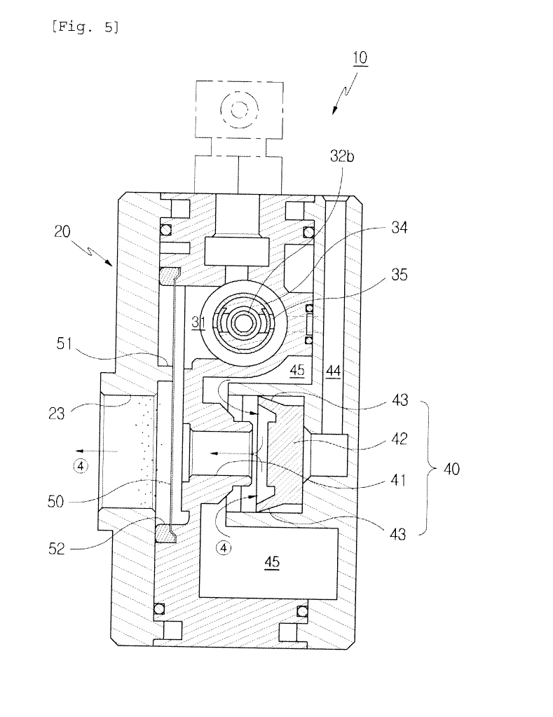

Referring to FIG. 2 and FIG. 4, a suction pad (not shown) is connected to the suction port 23 of the casing, in which the suction pad will be, of course, in contact with the surface of an object to be transported. In this state, when the compressed air is supplied through the inlet 21 of the casing 20, the vacuum pump part 30 operates. The compressed air passes sequentially through the nozzles 32a, 32b and 32c disposed inside the cartridge 36 at a high speed before being ejected to the outside through the silencer 37 coupled to the outlet 22 (see arrow \textcircled{1} in FIG. 2).

In this process, the pressure is decreased in the portions between the nozzles 32a, 32b and 32c, so that the air inside the suction pad is introduced into the nozzles 32a, 32b and 32c sequentially through the suction port 23, the filter material 50, the hollow area 31, the through-holes 35 and the slots 33. The air is then ejected to the outside along with the compressed air (see arrow \textcircled{2} in FIG. 4). This evacuation consequently creates vacuum or a negative pressure in the space inside the suction pad, which can then hold and transport the object by the negative pressure.

A portion of the initial compressed air supplied to the inlet 21 flows the passage 44 which starts from the side of the inlet 21, closes the support tube 41 by pressing against the head of the valve 42, and at the same time, continuously flows into the pressure chamber 45 while pressing against the skirt 43 portion. Consequently, the pressure chamber 45 is filled with the compressed air (see arrow \textcircled{3} in FIG. 4), which is used for the release).

Referring to FIG. 5, once the object has been transported, the supply of the compressed air is stopped, thereby stopping the operation of the vacuum pump part 30. Consequently, the air inside the pressure chamber 45 flows backward as a great force that was pressing against the head of the valve 42 disappears.

At this time, the skirt 43 and the valve 42 rise by the compressed air that flows backward, and the upper opening of the support tube 41 is then opened, so that the compressed air flows from the pressure chamber 45 sequentially through the support tube 41, the filter material 50 and the suction port 23 into the space inside the suction pad (see arrow \textcircled{4}). Accordingly, the vacuum or negative pressure that is created by the apparatus of the present invention is instantly released.

The apparatus 10 according to the present invention has an evacuation/release mechanism that separately stores part of the evacuating compressed air and uses it for releasing the vacuum when the vacuum state is stopped. Therefore, this apparatus can be more simply designed and embodied than the design of the related art that depends on an electronic mechanism for the evacuation and release operations. In addition, this apparatus can uniformly and accurately operate continuously, and in particular, the release of vacuum is quickly carried out.

When the vacuum pump part 30 operates, the air discharged from the suction pad is filtered while passing through the filter material 50. Therefore, impurities stick to the bottom of the filter material 50 (see FIG. 4). When the operation of the vacuum pump part 30 is stopped, the compressed air that has passed through the support tube 41 passes through the filter material 50 from top to bottom and flows into the suction port 23.

In this process, impurities that have been stuck to the bottom of the filter material 50 during the evacuation are detached and removed. Consequently, the cleaning of the filter material 50 is naturally and repeatedly carried out even though the cleaning is not separately carried out. The check valve 42, the support tube 41, the filter material 50 and the suction port 23 are arranged in the top-bottom relation in a line in order to realize the structure for quick release and effective filter cleaning, and this arrangement is determined to be advantageous over any other arrangements.

1. A quick-release vacuum pump constructed inside a casing which includes a compressed air inlet and a compressed air outlet formed in opposing side sections and a suction port formed in a bottom, the quick-release vacuum pump comprising:
a vacuum pump part which comprises a cylindrical hollow area which extends through the casing between the inlet and the outlet, one portion of the hollow area communicating with the suction port, nozzles which are disposed in series inside the hollow area and have slots therein, both ends of the nozzles communicating with each other between the inlet and the outlet;
a release part which comprises a support tube which is formed above the suction port, a skirt-type check valve which is moved up and down by air pressure to open and close an upper portion of the support tube, and a pressure chamber which is formed at a terminal of a passage which communicates with the suction port and passes by a valve skirt; and
a filter material which is disposed between the suction port and the support tube, wherein the filter material allows discharge air that is introduced to pass through upward when the pump part operates and is cleaned by air that is supplied to the suction port below through the support tube from the pressure chamber when the pump part stops operating.

2. The quick-release vacuum pump according to claim 1, wherein the nozzles are disposed inside a cylindrical body which has a through-hole in a wall, thereby forming one pump cartridge, with which the nozzles are mounted inside the hollow area.

3. The quick-release vacuum pump according to claim 1, wherein mounting ribs are formed on an upper end of the suction port such that the filter material is firmly mounted.

4. The quick-release vacuum pump according to claim 1, wherein the check valve, the support tube, the filter material and the suction port are arranged in a top-bottom relation in a line.
